(19) United States
(12) Patent Application Publication
(10) Pub. No.: US 2024/0017985 A1
(43) Pub. Date: Jan. 18, 2024

(54) Cake Beverage Dispenser

(71) Applicant: Nino Neilson, Charlotte, NC (US)

(72) Inventor: Nino Neilson, Charlotte, NC (US)

(21) Appl. No.: 17/863,030

(22) Filed: Jul. 12, 2022

(51) Int. Cl. B67D 3/00

(52) U.S. Cl. CPC B67D 3/0067; B67D 3/0096

(57) ABSTRACT

An article of manufacture for providing a cake beverage dispenser useful for birthdays and other celebrations according to the present invention is disclosed. The beverage dispenser includes an external container for holding beverages, the external container having a shape of a decorated cake associated with a celebration, an internal cavity in the external container for storing the beverage, and a dispensing spout. The dispensing spout has a beverage channel, an external end, and an opening and closing valve. The dispensing spout is coupled to the external container connecting the internal container.

### TECHNICAL FIELD

This application relates in general to an article of manufacture for providing a beverage dispensing device, and more specifically, to an article of manufacture providing a celebratory cake beverage dispenser useful for birthday or any celebration involving a cake, including but not limited to weddings, bachelor/bachelorette parties, etc.

### BACKGROUND

Millions of milestones are celebrated each year, especially birthdays and weddings. When people host a celebration, they often decorate the premises and the tables holding food. Usually, beverages are served; often in a large, nondescript beverage dispenser that sits blandly on a table. The Cake beverage Dispenser allows it to be a centerpiece of any celebration.

Therefore, a need exists for an article of manufacture for providing a cake beverage dispenser useful for birthdays and other celebrations. The present invention attempts to address the limitations and deficiencies in prior solutions according to the principles and example embodiments disclosed herein.

### SUMMARY

In accordance with the present invention, the above and other problems are solved by providing a cake beverage dispenser useful for birthdays and other celebrations according to the principles and example embodiments disclosed herein.

In one embodiment, the present invention is an article of manufacture for providing a beverage dispenser useful for celebrations. The beverage dispenser includes an external container for holding beverages, the external container having a shape of a decorated cake associated with a celebration, an internal cavity in the external container for storing the beverage, and a dispensing spout. The dispensing spout has a beverage channel, an external end, and an opening and closing valve. The dispensing spout is coupled to the external container connecting the internal container.

In another aspect of the present invention, the beverage dispenser further comprises removable celebration decorations attachable to an outside surface of the external container In another aspect of the present invention, the removable celebration decorations comprise one or more candles.

In another aspect of the present invention, the candles comprise electrically powered light sources.

In another aspect of the present invention, the candles comprise candle wax and a candle wick.

In another aspect of the present invention, the celebration decorations are associated with one or more celebrations comprising a wedding shower, baby shower, a work retirement, and a religious celebration.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture providing a cake beverage dispenser useful for birthday celebrations according to the present invention.

FIG. 2 illustrates another embodiment of an article of manufacture providing a cake beverage dispenser useful for birthday celebrations according to the present invention.

FIGS. 3a-c illustrate a beverage reservoir within an article of manufacture providing a cake beverage dispenser useful for birthday celebrations according to the present invention.

### DETAILED DESCRIPTION

This application relates in general to an article of manufacture for providing a beverage dispensing device, and more specifically, to an article of manufacture providing a cake beverage dispenser useful for birthday celebrations according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing a cake beverage dispenser useful for birthday celebrations according to the present invention. The term user herein refers to one or more users.

The term “invention” or “present invention” refers to the invention being applied for via the patent application with the title “Cake Beverage Dispenser.” Invention may be used interchangeably with dispenser.

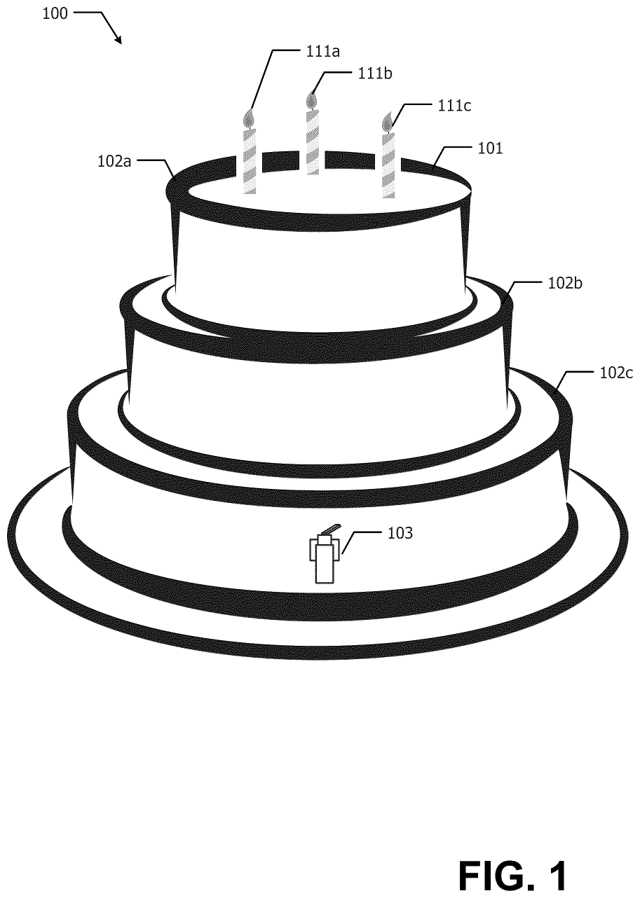

In general, the present disclosure relates to an article of manufacture providing a cake beverage dispenser useful for birthday celebrations according to the present invention. To better understand the present invention, FIG. 1 illustrates an example embodiment of an article of manufacture providing a cake beverage dispenser useful for birthday celebrations according to the present invention. In order to create a celebratory environment for a birthday celebration, a beverage dispenser 100 may be used to provide drinks to individuals attending a birthday party. In a preferred embodiment, a beverage dispenser 100 is shown to be shaped as a multi-layer birthday cake 102a-c. The beverage dispenser 100 may include one or more candles 111a-111c and any other markings to adorn the beverage dispenser 100 as desired. The beverage dispenser 100 comprises an external container 101 having an internal cavity (not shown) that acts as a reservoir for holding a beverage to be dispensed at a birthday party to attendees.

The candles 111a-111c may be replaceable wax candles that may be lit in an ordinary fashion. The candles 111a-111c may also be facsimiles for wax candles that use an electric light source to illuminate the flame portion of the candles 111a-111c.

A dispensing spout 103 is positioned about a bottom of the internal cavity to permit the beverage contents of the beverage dispenser 100 to be obtained by party attendees. The dispensing spout 103 comprises a beverage channel from the internal cavity to an external end of the dispensing spout 103 and an opening and closing valve to permit attendees to open and close the dispensing spout 103 to obtain a beverage.

While the embodiments disclosed herein present a cake that has been decorated to represent a birthday cake, the beverage dispenser 100 may present a decorated cake used in many types of different celebrations. For example, the beverage dispenser 100 may be decorated with words and items that celebrate a wedding or baby shower, a work retirement, religious celebrations, and any other event in which a decorated cake is typically presented. The decorations on the beverage dispenser 100, for example, the candles 111a-c, may be replaced with other items that are associated with the particular event in which it is being used. The candles 111a-c may be removed, and alternate items may be inserted into the same coupling points in their place. Additionally, words and related decorations used to personalize the cake for one or more individuals may also be removed and replaced from the beverage dispenser 100 as appropriate.

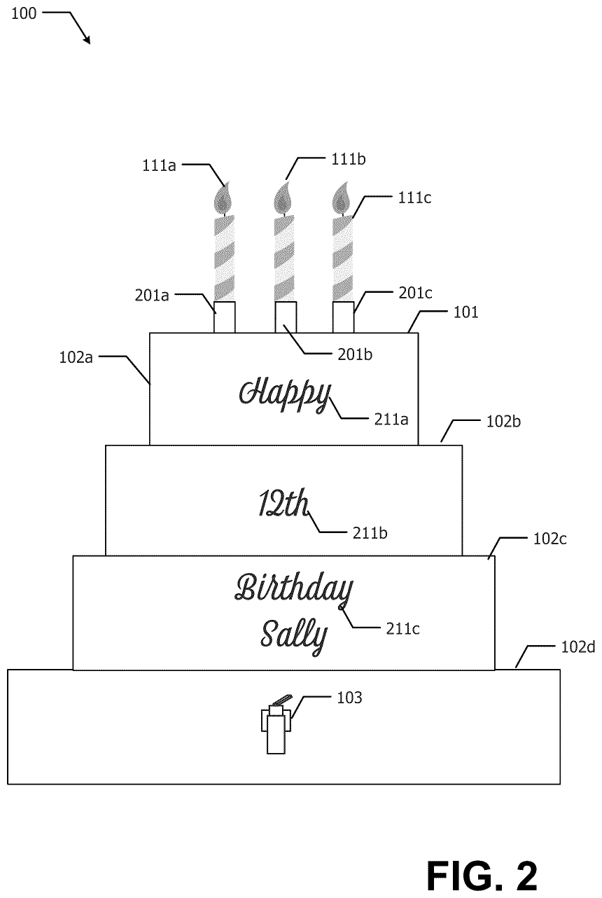

FIG. 2 illustrates another embodiment of an article of manufacture providing a cake beverage dispenser useful for birthday celebrations according to the present invention. In this second embodiment 200, the beverage dispenser 200 comprises four layers 102a-d to the representation of a birthday cake. The beverage dispenser 100 also may comprise external markings 211a-c to identify the guest of honor and details including an age 211b and name 211c. These external markings 211a-c may be permanently coupled to the outside of the beverage dispenser 200 or may be removable to permit the beverage dispenser 200 to be customized for each guest of honor and their particular age or celebration. The dispensing spout 103 is positioned at the bottom of the internal cavity (not shown) as disclosed above with reference to FIG. 1.

Additionally, wax candles 111a-111c are held in place by a corresponding set of candle holders 201a-c positioned on a top surface of the beverage dispenser 200. Each of the candle holders 201a-c may rise above the top surface 101 of the beverage dispenser 200 in this embodiment. In alternate embodiments, the candle holders 201a-c may be recessed within the top surface 101 of the beverage dispenser 200.

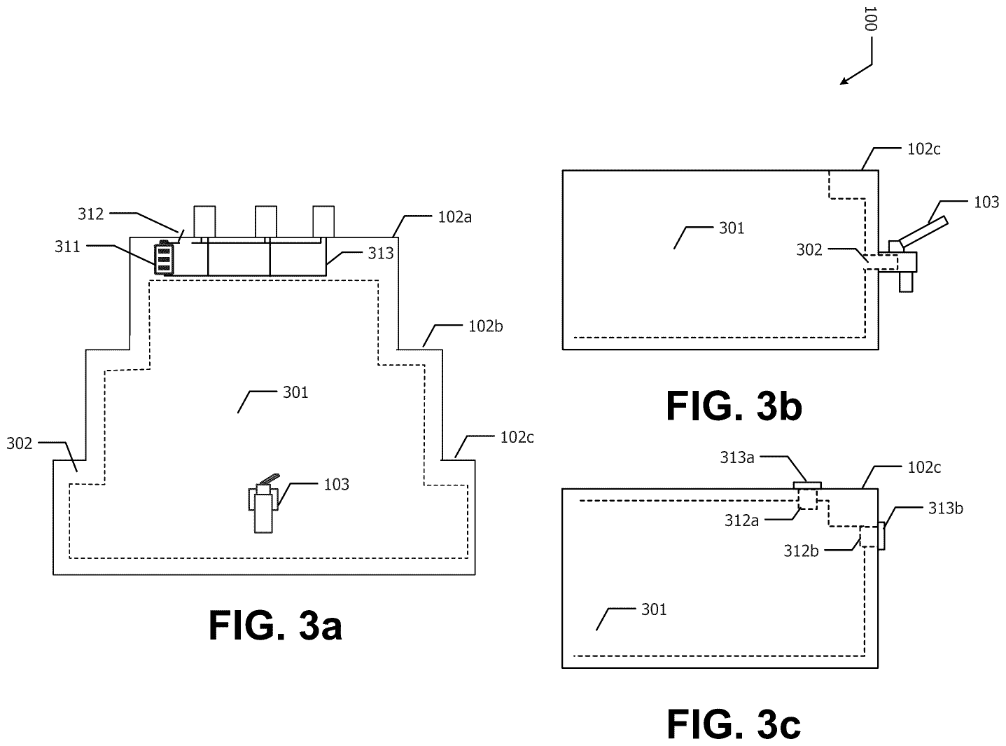

FIGS. 3a-c illustrate a beverage reservoir within an article of manufacture providing a cake beverage dispenser useful for birthday celebrations according to the present invention. FIG. 3a shows a cutaway view of the beverage dispenser 300 showing the internal cavity 301 contained within a thermal protection material 302 surrounding the internal cavity 301. The dispensing spout 103 is shown near the bottom of the internal cavity 301 to permit all of the reservoir to be drained out of the beverage dispenser 300. In the embodiment of FIG. 3a, an electrical circuit 313 connects a battery 311 and an on/off switch 312 to electrical light sources in facsimile candles (not shown).

FIG. 3b shows the dispensing spout 103 having a beverage channel 302 between the reservoir of the inner cavity 301 to the external end of the spout 303. A control lever 304 is shown on top of the dispensing spout 103 that opens and closes a valve within the dispensing spout 103 to control the flow of the beverage out of the beverage dispenser 300.

FIG. 3c shows a top portion of the beverage dispenser 300 having one or more openings 312a-b from the internal cavity 301 to outside of the beverage dispenser 300. These openings 312a-b may be covered by a removable lid 313a-b and may be used to provide an opening when the beverage contents of the beverage dispenser 300 is to fill the reservoir of the inner cavity 301. These openings may also provide a vent to allow air to enter the internal cavity 301 preventing creation of a vapor lock within the internal cavity 301 as the beverage contents of the beverage dispenser 300 are removed. Both of these openings 312a-b are positioned on the beverage dispenser 300 above a point at which the reservoir of the internal cavity 300 is considered full.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing a celebration beverage dispenser useful for birthday celebrations according to the present invention, the beverage dispenser comprises:
an external container for holding beverages, the external container having a shape of a decorated cake associated with a celebration;
an internal cavity in the external container for storing the beverage; and
a dispensing spout having a beverage channel, an external end, and an opening and closing valve, the dispensing spout being coupled to the external container connecting the internal container.

2. The beverage dispenser according to claim 1, wherein the beverage dispenser further comprises removable celebration decorations attachable to an outside surface of the external container.

3. The beverage dispenser according to claim 2, wherein the removable celebration decorations comprise one or more candles.

4. The beverage dispenser according to claim 3, wherein the candles comprise electrically powered light sources.

5. The beverage dispenser according to claim 3, wherein the candles comprise candle wax and a candle wick.

6. The beverage dispenser according to claim 2, wherein the celebration decorations are associated with one or more celebrations comprising a wedding shower, baby shower, a work retirement, and a religious celebration.
